(19) United States
(12) Patent Application Publication
(10) Pub. No.: US 2012/0159598 A1
(43) Pub. Date: Jun. 21, 2012

(54) USER AUTHENTICATION SYSTEM AND METHOD USING PERSONAL IDENTIFICATION NUMBER

(75) Inventors: SEUNG-HYUN KIM, DAEJEON (KR); DAE SEON CHOI, DAEJEON (KR); SOO HYUNG KIM, DAEJEON (KR); JONG-HYOUK NOH, DAEJEON (KR); SANG RAE CHO, DAEJEON (KR); YOUNG SEOB CHO, DAEJEON (KR); SEUNG HUN JIN, DAEJEON (KR)

(73) Assignee: ELECTRONICS AND TELECOMMUNICATION RESEARCH INSTITUTE, DAEJEON (KR)

(21) Appl. No.: 13/331,137

(22) Filed: Dec. 20, 2011

(30) Foreign Application Priority Data
Dec. 21, 2010 (KR) 10-2010-0131488

(51) Int. Cl. G06F 21/20

(52) U.S. Cl. 726/7

(57) ABSTRACT

A user authentication system using a personal identification number, includes a user terminal device for requesting issuance of a personal identification number from an authentication server, storing and displaying a personal identification number, and registering reference information used to permit verification of validity of the personal identification number on the authentication server. Further, the user authentication system includes an inquiry device for requesting verification of validity of the personal identification number from the authentication server, and receiving and displaying results of the verification. Furthermore, the user authentication system includes an authentication server for storing issuance information while issuing the personal identification number, determining whether to permit the verification of the validity of the personal identification number, if the inquiry device requests the verification of the validity, and replying with results of the verification, if it is determined that the verification of the validity is to be permitted.

### CROSS-REFERENCE TO RELATED APPLICATION(S)

The present invention claims priority of Korean Patent Application No. 10-2010-0131488, filed on Dec. 21, 2010, which is incorporated herein by reference.

### FIELD OF THE INVENTION

The present invention relates generally to user authentication using personal identification numbers; and, more particularly, to a user authentication system and method, which process the authentication of users using personal identification numbers that have been previously issued to users whose identities have been verified, when offline transactions on products or services are conducted.

### BACKGROUND OF THE INVENTION

As is well known to those skilled in the art, real name authentication technology is an online service for verifying the identity of each person using a combination of the resident registration number and the name of the person. Most online websites provide services to users who have passed a real name authentication procedure. However, information about resident registration numbers and names has already been used in several large-scale hacking incidents and, in addition, makes it difficult to correctly perform an identity authentication function as an original function due to the leakage of the information of offline businesses.

In order to solve the problem, there has been proposed a technology for processing user authentication using an I-PIN (Internet-Personal Identification Number) upon conducting online transactions. Such an I-PIN authentication technology is configured to perform real name authentication using a channel via which an identity can be primarily verified, such as a card, a mobile phone, or a certificate, and to then vouch for the identity of a relevant user to other online websites.

However, such a conventional user authentication technology using an I-PIN is problematic in that its use is limited to only online transactions. In offline transactions, a resident registration number and a name are still effectively used. In offline transactions, it is possible to identify a user while comparing the face of the user with that on an identification (ID) card, but incidents of misappropriating ID cards have increased. Further, since the misappropriation of ID cards is mainly used for crimes, it has far-reaching effects compared to online transactions. Accordingly, various technologies have been introduced to prevent the forgery of ID cards, but forgery technology has also been highly developed and it is difficult to determine whether forgery has occurred in various environments.

### SUMMARY OF THE INVENTION

In view of the above, the present invention provides a user authentication system and method, which process the authentication of users using personal identification numbers that have been previously issued to users whose identities have been verified, when offline transactions on products or services are conducted, thus providing high convenience while improving the security of offline transactions.

In accordance with a first aspect of the present invention, there is provided a user authentication system using a personal identification number, including: a user terminal device for requesting issuance of a personal identification number from an authentication server, storing and displaying a personal identification number issued by the authentication server, and registering reference information used to permit verification of validity of the personal identification number on the authentication server; an inquiry device for requesting verification of validity of the personal identification number from the authentication server and thereafter receiving and displaying results of the verification; and an authentication server for storing issuance information while issuing the personal identification number in response to a request of the user terminal device, determining whether to permit the verification of the validity of the personal identification number, based on results of a comparison between the information received from the inquiry device and the reference information if the inquiry device requests the verification of the validity, and replying with results of the verification based on the results of a comparison between the personal identification number received from the inquiry device and the issuance information if it is determined that the verification of the validity is to be permitted.

In accordance with a second aspect of the present invention, there is provided a user terminal device, including: a personal identification number requesting unit for requesting issuance of a personal identification number from an authentication server and receiving the personal identification number issued by the authentication server; a provider registration unit for registering, on the authentication server, reference information that is used when an inquiry device requests verification of validity of the personal identification number from the authentication server via a provider of products or services and the authentication server determines whether to permit the verification of the validity; a personal identification number storage unit for storing the personal identification number received by the personal identification number requesting unit; and a display unit for displaying the personal identification number received by the personal identification number requesting unit.

In accordance with a third aspect of the present invention, there is provided an inquiry device, including: a personal identification number verification unit for transmitting a personal identification number, which is issued by an authentication server and is displayed by the user terminal device, to the authentication server, requesting verification of validity of the personal identification number from the authentication server, and receiving results of the verification of the validity from the authentication server in reply to the request; and a display unit for displaying the results of the verification received by the personal identification number verification unit.

In accordance with a fourth aspect of the present invention, there is provided an authentication server, including: a personal identification number service unit for issuing a personal identification number in response to a request of a user terminal device, for generating issuance information while transmitting the personal identification number to the user terminal device, and for replying with results of verification of validity of the personal identification number based on results of a comparison between the personal identification number and the issuance information when an inquiry device having received the personal identification number requests the verification of the validity of the personal identification number; a personal identification number storage unit for storing the personal identification number and the issuance information; a provider verification unit for, when the user terminal device has previously registered reference information used to determine whether to permit the verification of the validity, determining whether to permit the verification of the validity, based on results of a comparison between the information received from the inquiry device by a provider of products or services and the reference information, and transferring results of the determination to the personal identification number service unit.

In accordance with a fifth aspect of the present invention, there is provided a user authentication method using a personal identification number, the method being performed by a user authentication system using a personal identification number, including: issuing the personal identification number; generating and storing issuance information based on issuance of the personal identification number; receiving registration of reference information used when determining whether to permit verification of validity of the personal identification number; when the verification of the validity of the personal identification number is requested, determining whether to permit the verification of the validity based on results of a comparison with the reference information; and if it is determined that the verification of the validity is to be permitted, providing results of the verification based on results of a comparison between the personal identification number and the issuance information.

As described above, user authentication technology using a personal identification number in accordance with the embodiments of the present invention has the following one or more advantages.

First, there is the advantages of using a uniquely allocated number based on an online i-pin authentication technology, thus making it difficult for a third party to acquire and forge the number, and of a user being able to update a personal identification number at each time and discard a personal identification number after a single use, thus providing high security.

Second, a user can freely use an online i-pin as his or her identification information upon making offline transactions, and a provider can easily verify each user via a channel such as a wired/wireless telephone, a smart phone, a computer, or the Internet, thus providing high convenience.

Third, the user may perform settings such that his or her relevant i-pin can be verified only by a specific service provider or may limit the settings such that the explicit approval of the user can be obtained whenever an i-pin is verified, thus minimizing damage caused by the leakage of authentication information. For example, even if a third party acquires the i-pin of the user, the approval of the user is required at the time at which the validity of the acquired i-pin is verified by another provider (service provider), thus preventing damage caused by the lost i-pin.

### BRIEF DESCRIPTION OF THE DRAWINGS

The objects and features of the present invention will become apparent from the following description of embodiments given in conjunction with the accompanying drawings, in which:

FIG. 1 is a block diagram showing a user authentication system using a personal identification number in accordance with an embodiment of the present invention;

FIG. 2 is a flow chart showing a service request/response procedure performed between a user terminal device and an authentication server in accordance with an embodiment of the present invention;

FIG. 3 is a flow chart showing a procedure in which the user terminal device is issued with a personal identification number and registers an inquiry device in accordance with an embodiment of the present invention;

FIG. 4 is a diagram illustrating screens displayed when the user terminal device checks a personal identification number (e.g., an i-pin) in accordance with an embodiment of the present invention;

FIG. 5 is a diagram illustrating screens displayed when the user terminal device updates a personal identification number (e.g., an i-pin) in accordance with an embodiment of the present invention;

FIGS. 6A and 6B are diagrams illustrating screens displayed when the user terminal device sets an inquiry device (e.g., inquiry service provider) desired to be permitted to verify the validity of a personal identification number (e.g., an i-pin) in accordance with an embodiment of the present invention;

FIG. 7 is a flow chart showing a procedure in which the authentication server processes a request for verifying a personal identification number (e.g., an i-pin) via the inquiry device (e.g., an inquiry service provider) in accordance with an embodiment of the present invention;

FIG. 8 is a diagram illustrating screens displayed when the inquiry device verifies a personal identification number (e.g., an i-pin) in accordance with an embodiment of the present invention;

FIG. 9 is a diagram illustrating screens displayed when the inquiry device fails to verify a personal identification number (e.g., an i-pin) in accordance with an embodiment of the present invention; and

FIGS. 10A and 10B are diagrams illustrating screens displayed when the inquiry device requests the verification of a personal identification number (e.g., an i-pin) and the user terminal device approves the personal identification number in accordance with an embodiment of the present invention.

### DETAILED DESCRIPTION OF THE EMBODIMENTS

Embodiments of the present invention will be described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram.

Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective sequences of the sequence diagram.

Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

Hereinafter, embodiments of the present invention will be described in detail with reference to the accompanying drawings which form a part hereof.

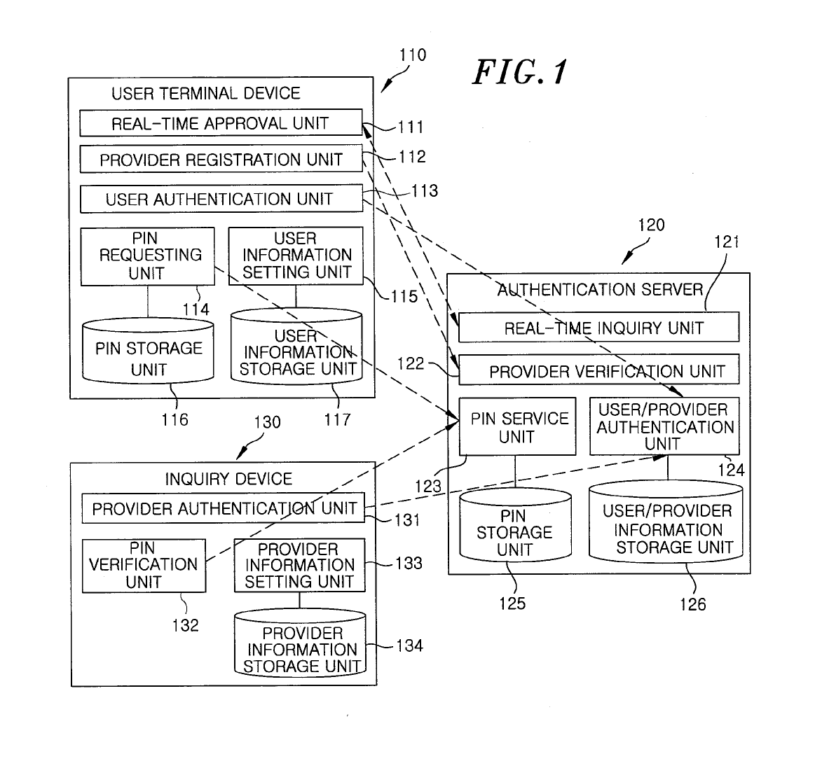

FIG. 1 is a block diagram showing the construction of a user authentication system using a Personal Identification Number (PIN) in accordance with an embodiment of the present invention.

Referring to FIG. 1, the user authentication system includes a user terminal device 110, an authentication server 120, and an inquiry device 130.

The user terminal device 110 requests the issuance of a PIN from the authentication server 120, stores and displays the PIN issued by the authentication server 120, and registers reference information, used to verify the validity of a PIN, on the authentication server 120. The user terminal device 110 displays the details of a verification request received from the authentication server 120 and replies by sending selection information, input in response to the verification request details, to the authentication server 120.

The authentication server 120 stores the issuance information while issuing a PIN in response to the request of the user terminal device 110. If the inquiry device 130 requests the verification of validity, the authentication server 120 determines whether to permit the verification of validity, on the basis of the results of a comparison between the information received from the inquiry device 130 and the reference information. If it is determined that the verification of the validity is to be permitted, the authentication server 120 replies with the results of verification based on the results of a comparison between the PIN received from the inquiry device 130 and the issuance information. The authentication server 120 transmits the details of the verification request for the PIN to the user terminal device 110 if the inquiry device 130 requests the verification of the validity, and replies with either the results of the verification or a denial message depending on selection information received from the user terminal device 110.

After requesting the verification of validity of the PIN from the authentication server 120, the inquiry device 130 receives and displays the results of the verification.

The user terminal device 110 includes a real-time approval unit 111, a provider registration unit 112, a user authentication unit 113, a PIN requesting unit 114, a user information setting unit 115, a PIN storage unit 116, a user information storage unit 117, and a display unit (not shown).

The PIN requesting unit 114 requests the issuance of a PIN from the authentication server 120, and receives the PIN issued by the authentication server 120.

The service registration unit 112 registers on the authentication server 120 reference information used when the inquiry device 130 requests the verification of validity of a PIN from the authentication server 120 via the provider of products or services, and the authentication server 120 determines whether to permit the verification of the validity of the PIN.

The PIN storage unit 116 stores the PIN received by the PIN requesting unit 114.

The display unit (not shown) displays the PIN received by the PIN requesting unit 114 so that the user can recognize the PIN.

When the inquiry device 130 requests the verification of validity and the authentication server 120 transmits the details of the validity verification request for the PIN, the real-time approval unit 111 displays the verification request details via a display unit (not shown), and replies by sending the input selection information to the authentication server 120, thus allowing the authentication server 120 to reply with the results of the verification or reply with a denial message depending on the selection information.

The user information setting unit 115 receives the ID and the password of the user, which have been previously registered on the authentication server 120.

The user information storage unit 117 stores the ID and the password of the user.

The user authentication unit 113 performs a procedure for authenticating the user by transmitting the ID and the password of the user to the authentication server 120.

The inquiry device 130 includes a provider authentication unit 131, a PIN verification unit 132, a provider information setting unit 133, a provider information storage unit 134, a display unit (not shown) and the like.

The PIN verification unit 132 transmits a PIN, issued by the authentication server 120 and displayed on the user terminal device 110, to the authentication server 120, and then requests the verification of the validity of the PIN from the authentication server 120 and receives the results of the verification of the validity from the authentication server 120 in reply to the verification request.

The display unit (not shown) displays the results of the verification received by the PIN verification unit 132 so that the results may be recognized by a provider (e.g., the operator of the inquiry device 130 or an inquiry service provider).

The provider information setting unit 133 receives the ID and the password of the provider that have been previously registered on the authentication server 120.

The provider information storage unit 134 stores the ID and the password of the provider.

The provider authentication unit 131 performs a procedure for authenticating the provider by transmitting the ID and the password of the provider to the authentication server 120.

When the authentication procedure performed by the provider authentication unit 131 has been completed, the PIN verification unit 132 transmits the PIN to the authentication server 120.

The authentication server 120 includes a real-time inquiry unit 121, a provider verification unit 122, a PIN service unit 123, a user/provider authentication unit 124, a PIN storage unit 125, a user/provider information storage unit 126, etc.

The PIN service unit 123 issues a PIN in response to the request of the user terminal device 110 and generates issuance information while transmitting the PIN to the user terminal device 110. When the inquiry device 130 having received the PIN requests the verification of the validity of the PIN, the PIN service unit 123 replies with the results of the verification of the validity based on the results of a comparison between the PIN and the issuance information.

The PIN storage unit 125 stores the PIN and the issuance information.

When the user terminal device 110 has previously registered reference information used to determine whether to permit the verification of validity, the provider verification unit 122 determines whether to permit the verification of validity based on the results of the comparison between the information, received from the inquiry device 130 by the provider of products or services, and the reference information, and transmits the results of the determination to the PIN service unit 123.

The real-time inquiry unit 121 transmits the details of a validity verification request for the PIN to the user terminal device 110 when the inquiry device 130 requests the verification of the validity of the PIN. Then, the real-time inquiry unit 121 transfers the selection information, received from the user terminal device 110, to the PIN service unit 123, thus allowing the PIN service unit 123 to reply by sending the results of verification or a denial message to the user terminal device 110 depending on the selection information.

The user/provider information storage unit 126 stores the ID and the password of the user previously registered by the user terminal device 110 and the ID and the password of the provider previously registered by the inquiry device 130.

The user/provider authentication unit 124 processes the authentication of the user or the provider on the basis of the results of the comparison between the ID and the password received from the user terminal device 110 or the inquiry device 130 and the ID and the password previously stored in the user/provider information storage unit 126.

In the user authentication system including the above-described user terminal device 110, authentication server 120, and inquiry device 130, the functions and operations of individual components will be described in detail below on the basis of an embodiment in which an i-pin is used as the PIN, the ID (id) and a password (pw) are used as each of the user information and the provider information, and the authentication server 120 is an i-pin institution for providing a service for issuing and managing i-pins.

The user terminal device 110 stores user information (e.g., id and pw), registered on the authentication server 120, for example, an i-pin institution, in the user information storage unit 117, and stores a PIN issued by the i-pin institution, for example, an i-pin, in the PIN storage unit 116.

The id and the pw are received from the user by the user information setting unit 115, and the user authentication unit 113 performs an authentication procedure with the i-pin institution using the id and pw.

After the authentication procedure has been completed, the user terminal device 110 is issued with an i-pin from the i-pin institution via the PIN requesting unit 114, and stores the issued i-pin in the PIN storage unit 116. The user may set a provider (a service provider or an inquiry service provider) having the authority to make a verification request for a relevant i-pin to prevent a third party from inquiring about the user's own i-pin without permission. The provider registration unit 112 registers provider identification information (e.g., a business registration number) on the i-pin institution so that only a specific provider can make a verification request for the current i-pin. Further, the user can determine in real time whether to permit verification with respect to all verification requests of the provider, via the real-time approval unit 111. The results of verification are transferred to the provider only when the user explicitly checks all attempts to make a request for verifying the i-pin of the user from the time point at which the user activates the real-time approval unit 111.

The inquiry device 130 stores the provider information registered on the i-pin institution in the provider information storage unit 134. The provider information is received from a service provider by the provider information setting unit 133, and the provider authentication unit 131 performs an authentication procedure with the i-pin institution using the provider information. After the authentication procedure has been completed, the provider enters the i-pin of the user via the PIN verification unit 132 and receives confirmation about whether to verify the i-pin of the user.

The i-pin institution stores both the user information registered by the user and the provider information registered by the provider in the user/provider information storage unit 126, and also stores i-pins that have been issued to users in the PIN storage unit 125.

When the user terminal device 110 and the inquiry device 130 present the user information and the provider information, respectively, to the i-pin institution, the user/provider authentication unit 124 performs an authentication procedure for comparing the presented information with the information stored in the user/provider information storage unit 126. After passing the authentication procedure, the i-pin service requested by the user terminal device 110 and the inquiry device 130 is processed by the PIN service unit 123. When receiving an inquiry/update request for the i-pin of the user, the PIN service unit 123 returns or updates the i-pin of the PIN storage unit 125. Further, when receiving a verification request for the i-pin of the provider, the PIN service unit 123 loads a provider (an inquiry service provider) and information about whether real-time inquiry is possible, from the i-pin of the PIN storage unit 125. When the user registers the provider, the provider verification unit 122 determines whether the provider has the authority to verify the i-pin of the user. When the user sets real-time inquiry, the real-time inquiry unit 121 transfers the details of the verification quest for the i-pin of the provider to the user terminal device 110 and requests a response to the verification request details. If the user approves the request, the details of the verification of the i-pin are transferred to the provider, whereas if the user denies the request, a denial message is sent to the provider.

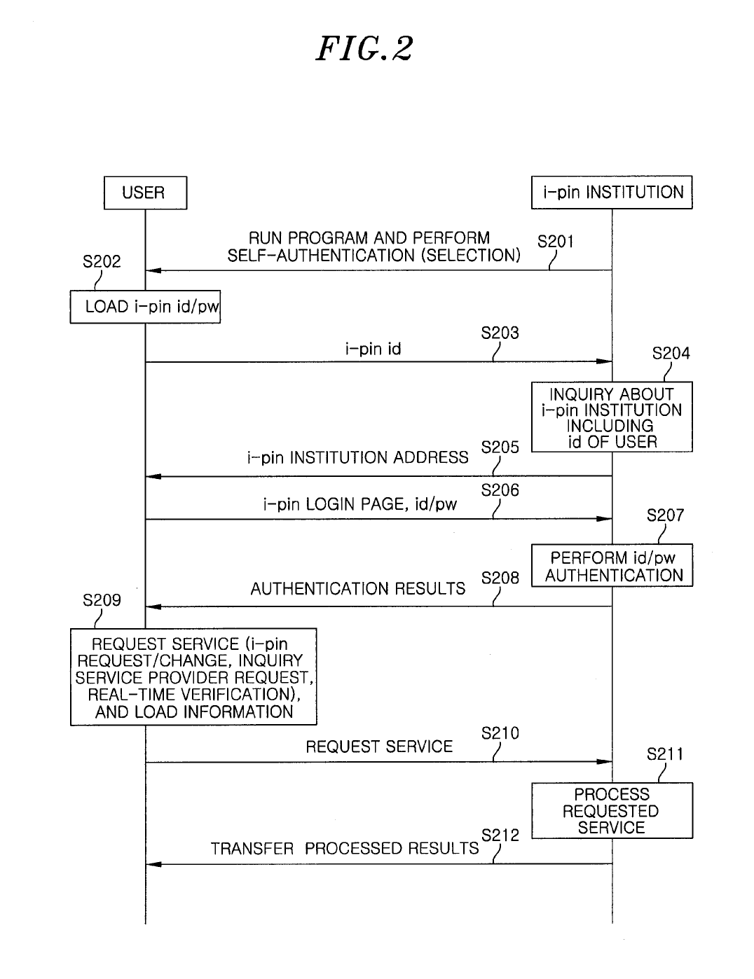

Hereinafter, a user authentication method performed by the user authentication system using a PIN in accordance with an embodiment of the present invention will be described in detail with reference to FIGS. 2 to 10.

FIG. 2 is a flow chart showing a service request/response procedure performed between the user terminal device and the authentication server in accordance with an embodiment of the present invention. In FIG. 2, it is assumed that an i-pin is used as the PIN, an id and a pw are used as each of user information and provider information, and an i-pin institution denotes an institution for providing a service for issuing and managing i-pins.

First, the user runs a program on the user terminal device 110 and performs a self-authentication procedure in step S201. When a specific service is executed, the id/pw information previously registered on the i-pin institution is loaded from the user information storage unit 117 to log into the i-pin institution in step S202. When the i-pin id is transmitted from the user terminal device 110 to the i-pin institution in step S203, the i-pin institution inquires about an i-pin institution including the id of the user in step S204, and returns the log-in address of the relevant institution in step S205. When the user terminal device 110 enters the id/pw into the login address field of the i-pin institution, and transfers the id/pw to the i-pin institution in step S206, the i-pin institution determines whether the received id/pw is identical to that stored in the user/provider information storage unit 126 in step S207, and replies with the results of the authentication in step S208. When the results of the authentication indicate a success, the user terminal device 110 sets information in conformity to the service to be requested in step S209, and requests a service from the i-pin institution in step S210. The i-pin institution processes the requested service in step S211, and transfers the processed results to the user terminal device 110 in step S212.

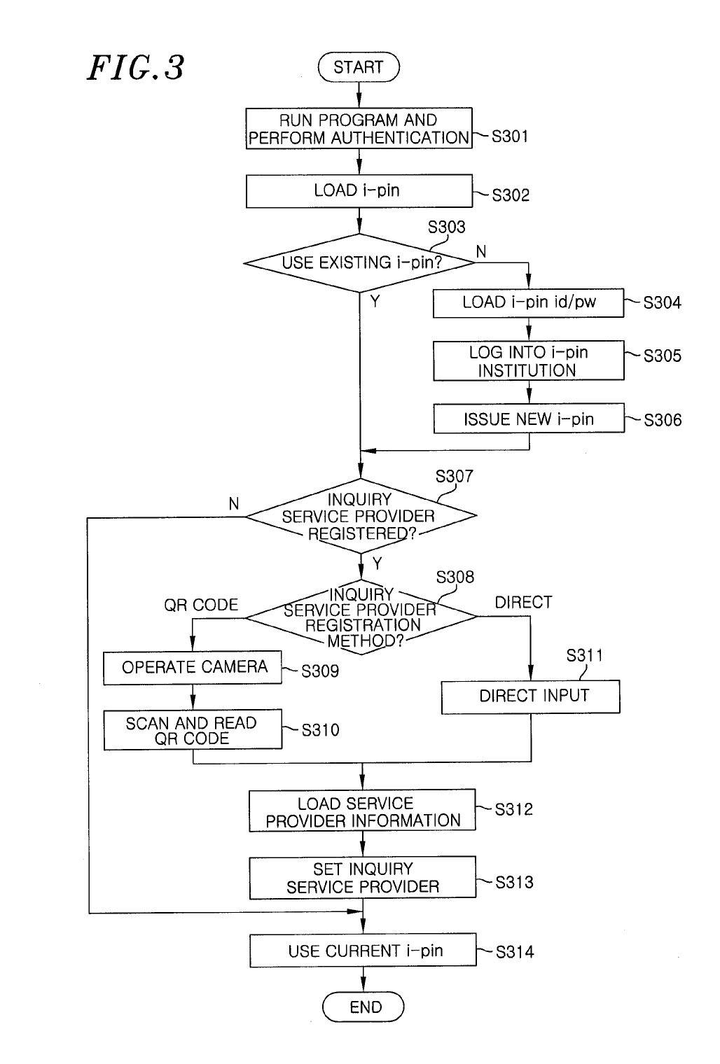

FIG. 3 is a flow chart showing a procedure in which the user terminal device is issued with a PIN and registers an inquiry device in accordance with an embodiment of the present invention. FIG. 3 illustrates an embodiment in which an i-pin is used as the PIN, an id and a password (pw) are used as each of user information and provider information (information about the operator of the inquiry device, for example, an inquiry service provider), and an i-pin institution is an i-pin institution for providing a service for issuing and managing i-pins.

First, the user runs a program on the user terminal device 110 and performs a self-authentication procedure in step S301. The user terminal device 110 loads an i-pin stored in the PIN storage unit 116 in step S302. When desiring to use his or her i-pin without change, the user proceeds to the step S307 of registering an inquiry service provider. Further, when desiring to be issued with a new i-pin, the user logs into the i-pin institution in step S305 and being issued with a new i-pin in step S306. When an inquiry service provider is registered in step S307, any one of a case where a Quick Response (QR) code is used and a case where an inquiry service provider is directly input is selected. When a QR code is used, the camera (not shown) of the user terminal device 110 is operated in step S309. Then, when the camera is focused on the QR code, the QR code is scanned and automatically read, and a provider identification code (e.g., a business registration number) is loaded in step S310. When an inquiry service provider is directly input by the user, the business registration number of the provider is input in step S311. The user terminal device 110 loads detailed information about the provider using the business registration number and displays the detailed provider information to the user in step S312. When the user confirms the setting of the inquiry service provider, the user sets the inquiry service provider in the i-pin institution in step S313. Further, the flow of the process is terminated by using the i-pin currently displayed on the user terminal device 110 in step S314. When an inquiry service provider is not registered, an i-pin loaded on the user terminal device 110 is used without being changed.

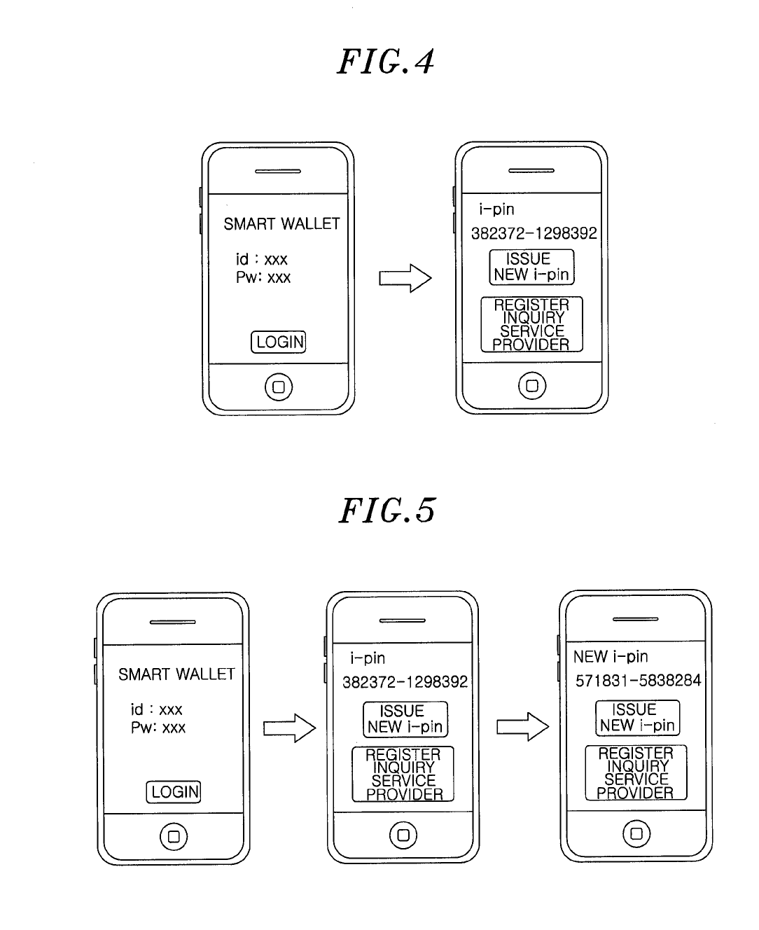

FIG. 4 illustrates screens displayed when the user terminal device checks a PIN (e.g., an i-pin) in accordance with an embodiment of the present invention. The screens illustrated in FIG. 4 correspond to steps S301 and S303 of FIG. 3.

FIG. 5 illustrates screens displayed when the user terminal device updates a PIN (e.g., an i-pin) in accordance with an embodiment of the present invention. The screens illustrated in FIG. 5 correspond to steps S301, S303 and S306 of FIG. 3.

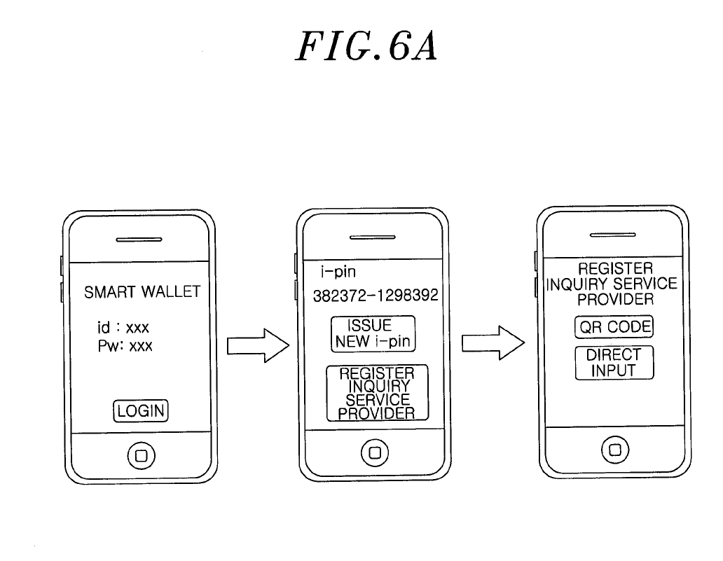

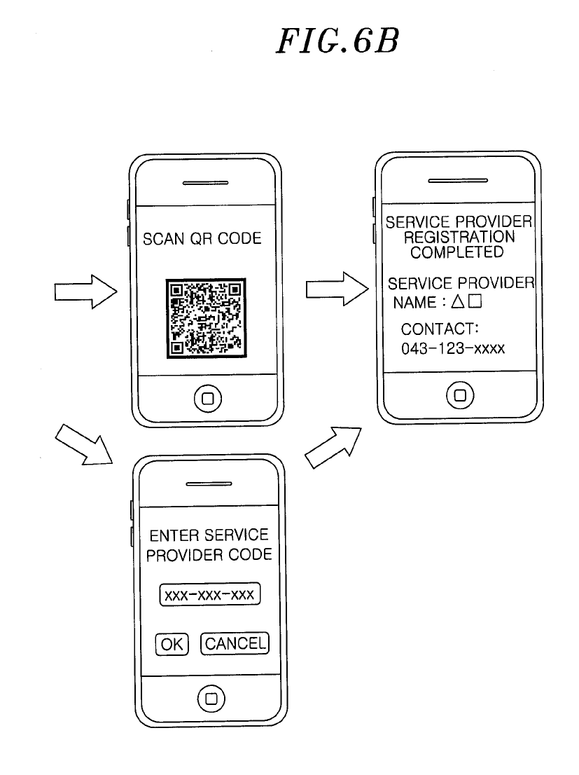

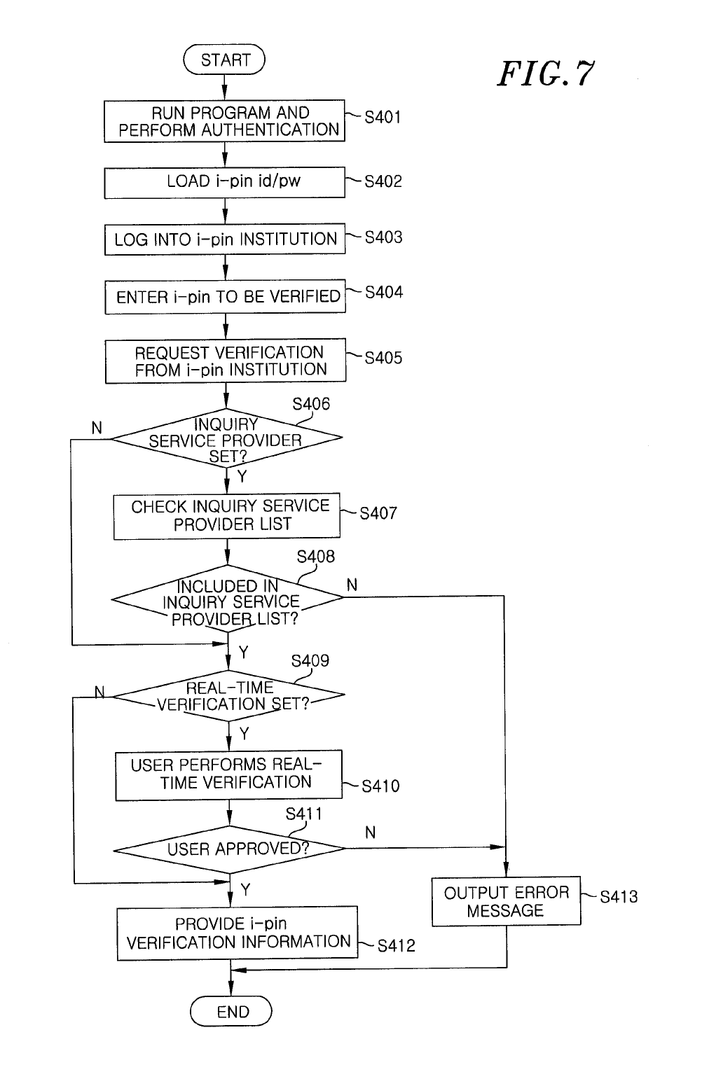

FIGS. 6A and 6B illustrate screens displayed when the user terminal device sets an inquiry device (e.g., an inquiry service provider) desired to be permitted to verify the validity of a PIN (e.g., an i-pin) in accordance with an embodiment of the present invention. The screens illustrated in FIGS. 6A and 6B correspond to steps S301, S303, and S307 to S312 shown in FIG. 3.

FIG. 7 is a flow chart showing a procedure in which the authentication server processes a verification request for a PIN (e.g., i-pin) via an inquiry device (e.g., an inquiry service provider) in accordance with an embodiment of the present invention. FIG. 7 shows an embodiment in which an i-pin is used as the PIN, an id and a pw are used as each of user information and provider information, and an i-pin institution is an i-pin institution for providing a service for issuing and managing i-pins.

First, the provider runs a program on the inquiry device 130 and performs its own authentication procedure in step S401. The inquiry device 130 loads i-pin id/pw stored in the provider information storage unit 134 in step S402, and then logs into the i-pin institution in step S403. The provider enters an i-pin, the validity of which is to be verified, into the inquiry device 130 in step S404, and requests verification from the i-pin institution in step S405. The i-pin institution determines whether the provider has been authenticated, and then loads information about the i-pin requested by the provider to be verified. When an inquiry service provider has been set in the i-pin in step S406, a list of inquiry service providers is checked, and then it is determined whether an identification code of the provider is included in the list in step S407. If the identification code of the provider is not included in the list in step S408, an error message is output in step S413 and the verification procedure is terminated. In contrast, if it is determined that the service provider is included in the inquiry service provider list in step S408 or if an inquiry service provider is not set in the i-pin in step S406, the process proceeds to step S409 of setting a real-time verification. If the user has set the real-time verification service, the i-pin institution notifies the user terminal device 110 of the i-pin verification request received from the provider in step S410. If the user approves the relevant verification in step S411, the i-pin institution provides information about the verification of the i-pin of the user in step S412 and terminates the flow of the process. If the user does not approve the relevant verification, the i-pin institution outputs an error message in step S413 and terminates the verification procedure.

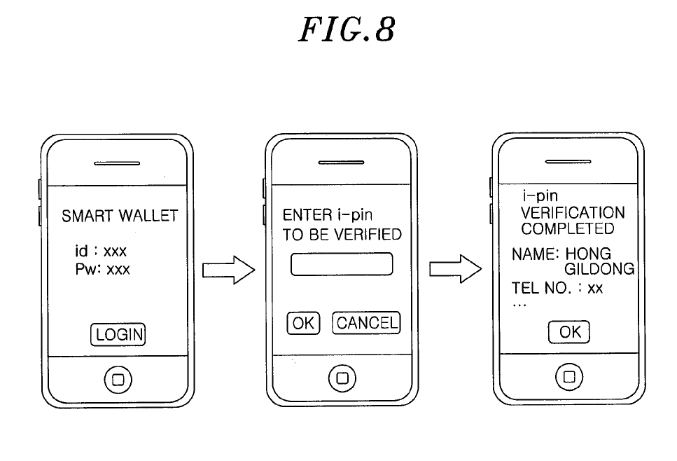

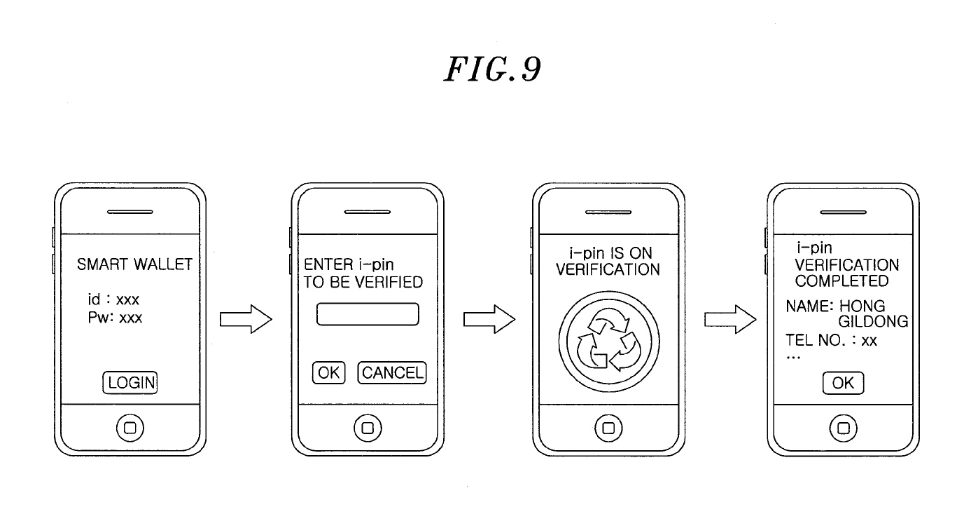

FIG. 8 illustrates screens displayed when the inquiry device verifies a PIN (e.g., an i-pin) in accordance with an embodiment of the present invention. The screens shown in FIG. 8 correspond to steps S401, S404, and S412 shown in FIG. 7.

FIG. 9 illustrates screens displayed when the inquiry device fails to verify a PIN (e.g., an i-pin) in accordance with an embodiment of the present invention. The screens illustrated in FIG. 9 correspond to steps S401, S404, S405, and S413 shown in FIG. 4.

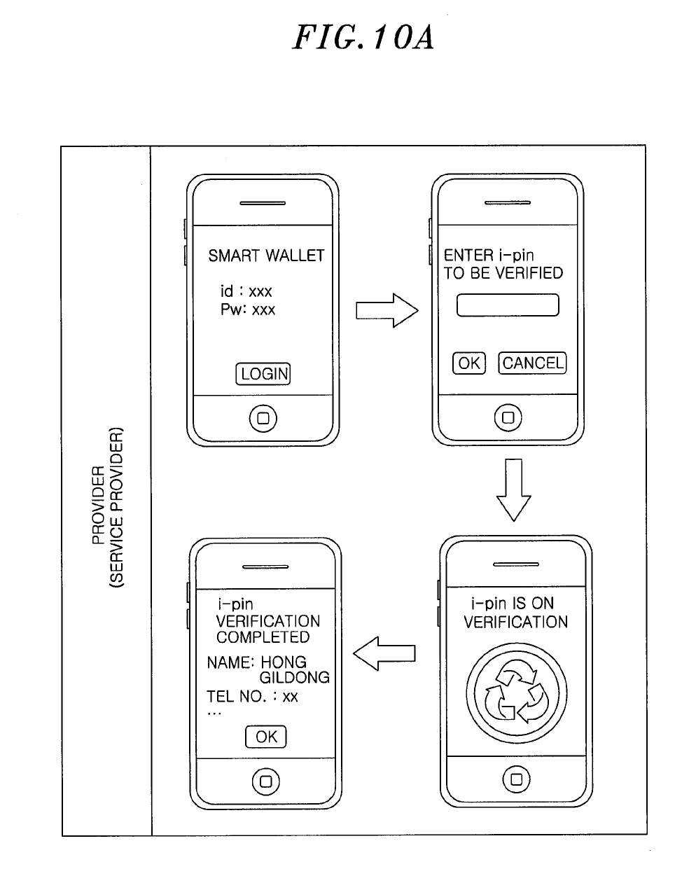

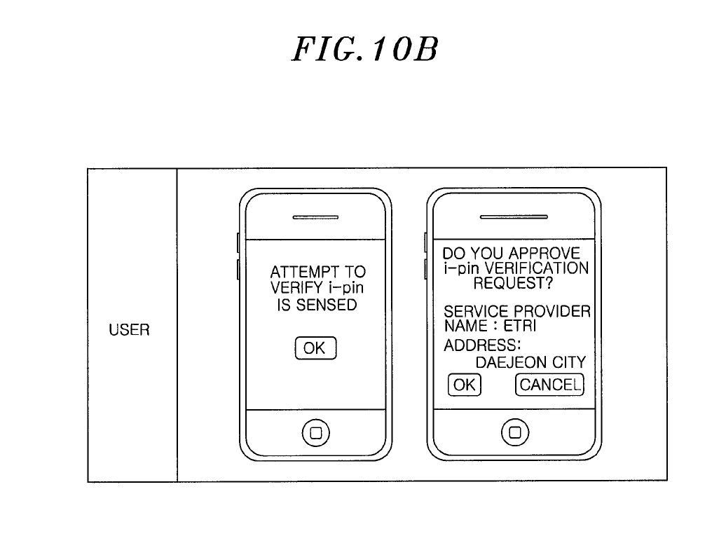

FIGS. 10A and 10B illustrate screens displayed when the inquiry device requests the verification of a PIN (e.g., an i-pin) and the user terminal device approves verification in real time in accordance with an embodiment of the present invention. The screens illustrated in FIGS. 10A and 10B correspond to steps S401, S404, S405, S410, and S412 shown in FIG. 4.

While the invention has been shown and described with respect to the embodiments, it will be understood by those skilled in the art that various changes and modifications may be made without departing from the scope of the invention as defined in the following claims.

What is claimed is:

1. A user authentication system using a personal identification number, comprising:
a user terminal device for requesting issuance of a personal identification number from an authentication server, storing and displaying a personal identification number issued by the authentication server, and registering reference information used to permit verification of validity of the personal identification number on the authentication server;
an inquiry device for requesting verification of validity of the personal identification number from the authentication server and thereafter receiving and displaying results of the verification; and
an authentication server for storing issuance information while issuing the personal identification number in response to a request of the user terminal device, determining whether to permit the verification of the validity of the personal identification number, based on results of a comparison between the information received from the inquiry device and the reference information if the inquiry device requests the verification of the validity, and replying with results of the verification based on the results of a comparison between the personal identification number received from the inquiry device and the issuance information if it is determined that the verification of the validity is to be permitted.

2. The user authentication system of claim 1, wherein:
the authentication server is configured to, if the inquiry device requests the verification of the validity, transmit details of a verification request for the personal identification number to the user terminal device, and reply with results of the verification or reply with a denial message depending on selection information received from the user terminal device; and
the user terminal device displays the details of the verification request, and thereafter replies by sending the selection information, input in response to the details of the verification request, to the authentication server.

3. A user terminal device, comprising:
a personal identification number requesting unit for requesting issuance of a personal identification number from an authentication server and receiving the personal identification number issued by the authentication server;
a provider registration unit for registering, on the authentication server, reference information that is used when an inquiry device requests verification of validity of the personal identification number from the authentication server via a provider of products or services and the authentication server determines whether to permit the verification of the validity;
a personal identification number storage unit for storing the personal identification number received by the personal identification number requesting unit; and
a display unit for displaying the personal identification number received by the personal identification number requesting unit.

4. The user terminal device of claim 3, further comprising a real-time approval unit configured to, if the inquiry device requests the verification of the validity and then the authentication server transmits details of a verification request for the personal identification number, display the details of the verification request on the display unit and reply by sending input selection information to the authentication server, thus allowing the authentication server to reply with results of the verification or reply with a denial message depending on the selection information.

5. The user terminal device of claim 3, further comprising:
a user information setting unit for receiving an Identification (ID) and a password of a user which have been previously registered on the authentication server;
a user information storage unit for storing the ID and the password; and
a user authentication unit for performing a procedure for authenticating the user by transmitting the ID and the password to the authentication server.

6. An inquiry device, comprising:
a personal identification number verification unit for transmitting a personal identification number, which is issued by an authentication server and is displayed by the user terminal device, to the authentication server, requesting verification of validity of the personal identification number from the authentication server, and receiving results of the verification of the validity from the authentication server in reply to the request; and
a display unit for displaying the results of the verification received by the personal identification number verification unit.

7. The inquiry device of claim 6, wherein the inquiry device comprises:
a provider information setting unit for receiving an Identification (ID) and a password of a provider which have been previously registered on the authentication server;
a provider information storage unit for storing the ID and the password; and
a provider authentication unit for performing a procedure for authenticating the provider by transmitting the ID and the password to the authentication server.

8. The inquiry device of claim 7, wherein the personal identification number verification unit transmits the personal identification number to the authentication server if the authentication procedure has been completed by the provider authentication unit.

9. An authentication server, comprising:
a personal identification number service unit for issuing a personal identification number in response to a request of a user terminal device, for generating issuance information while transmitting the personal identification number to the user terminal device, and for replying with results of verification of validity of the personal identification number based on results of a comparison between the personal identification number and the issuance information when an inquiry device having received the personal identification number requests the verification of the validity of the personal identification number;
a personal identification number storage unit for storing the personal identification number and the issuance information;
a provider verification unit for, when the user terminal device has previously registered reference information used to determine whether to permit the verification of the validity, determining whether to permit the verification of the validity, based on results of a comparison between the information received from the inquiry device by a provider of products or services and the reference information, and transferring results of the determination to the personal identification number service unit.

10. The authentication server of claim 9, further comprising a real-time inquiry unit for, when the inquiry device requests the verification of the validity, transmitting details of a verification request for the personal identification number to the user terminal device, and transferring selection information received from the user terminal device to the personal identification number service unit, so that the personal identification number service unit replies with results of the verification or replies with a denial message depending on the selection information.

11. The authentication server of claim 9, further comprising:
a user/provider information storage unit for storing an Identification (ID) and a password of a user which have been previously registered by the user terminal device, and an ID and a password of a provider which have been previously registered by the inquiry device; and
a user/provider authentication unit for processing authentication of the user or the provider based on results of a comparison between an ID and a password received from the user terminal device or the inquiry device and the ID and the password previously stored in the user/provider information storage unit.

12. A user authentication method using a personal identification number, the method being performed by a user authentication system using a personal identification number, comprising:
issuing the personal identification number;
generating and storing issuance information based on issuance of the personal identification number;
receiving registration of reference information used when determining whether to permit verification of validity of the personal identification number;
when the verification of the validity of the personal identification number is requested, determining whether to permit the verification of the validity based on results of a comparison with the reference information; and
if it is determined that the verification of the validity is to be permitted, providing results of the verification based on results of a comparison between the personal identification number and the issuance information.

13. The user authentication method of claim 12, wherein:
the determining whether to permit the verification of the validity is configured to, if a request for the verification of the validity is received from an inquiry device, transmit results of the verification request for the personal identification number to a user terminal device; and
the providing the results of the verification is configured to reply by sending the results of the verification or a denial message to the inquiry device depending on selection information of the user terminal device.

14. The user authentication method of claim 13, further comprising:
storing an Identification (ID) and a password of a user which have been previously registered by the user terminal device and an ID and a password of a provider which have been previously registered by the inquiry device; and
processing authentication of the user terminal device or the inquiry device based on results of a comparison between an ID and a password received from the user terminal device or the inquiry device and the previously stored ID and password.
